(19) United States
(12) Patent Application Publication
(10) Pub. No.: US 2026/0235846 A1
(43) Pub. Date: Aug. 13, 2026

(54) LENS MODULE

(71) Applicant: SAMSUNG ELECTRO-MECHANICS CO., LTD., Suwon-si (KR)

(72) Inventor: Jae Yeon PARK, Suwon-si (KR)

(73) Assignee: SAMSUNG ELECTRO-MECHANICS CO., LTD., Suwon-si (KR)

(21) Appl. No.: 19/447,336

(22) Filed: Jan. 13, 2026

(30) Foreign Application Priority Data
Feb. 7, 2025 (KR) 10-2025-0016112
Sep. 23, 2025 (KR) 10-2025-0137530

(51) Int. Cl. G02B 7/02; G02B 1/04

(52) U.S. Cl. CPC G02B 7/028; G02B 1/041; G02B 7/021

(57) ABSTRACT

A lens module includes a lens formed of a first material, and a lens barrel formed of a second material, different from the first material, and including an accommodation space accommodating the lens. A protrusion protruding toward an outer circumferential surface of the lens is disposed in the accommodation space, and conditional expression 0.3<G/X<0.8 is satisfied, where G is a distance between an end of the protrusion and the outer circumferential surface of the lens, and X is a maximum expansion deformation amount of the lens.

### CROSS-REFERENCE TO RELATED APPLICATIONS

This application claims the benefit under 35 USC 119 (a) of Korean Patent Application No. 10-2025-0016112 filed on Feb. 7, 2025, and Korean Patent Application No. 10-2025-0137530 filed on Sep. 23, 2025, in the Korean Intellectual Property Office, the entire disclosures of which are incorporated herein by reference for all purposes.

### BACKGROUND

### 1. Field

The present disclosure relates to a lens module capable of relieving expansion stress of a lens.

### 2. Description of the Background

A camera module may include a lens module for forming an image of light incident on an image sensor. The lens module may include a plurality of plastic lenses sequentially arranged along an optical axis and a lens barrel accommodating the plastic lenses. The lens module is one of several important components that determine performance and resolution of the camera module. For example, the performance and resolution of the camera module may be degraded if optical axes of lenses included in the lens module are not aligned within a tolerance range. For this reason, the lenses may be accommodated inside the lens barrel to be in close contact with an inner circumferential surface of the lens barrel. However, a close contact structure between the lenses and the lens barrel may excessively restrict expansion variation in the plastic lenses caused by an external temperature change, thereby causing breakage of the lenses or distortion of the optical axes of the lenses, which may significantly degrade the performance and resolution of the camera module.

The above information is presented as background information only to assist with an understanding of the present disclosure. No determination has been made, and no assertion is made, as to whether any of the above might be applicable as prior art with regard to the disclosure.

### SUMMARY

This Summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter.

In one general aspect, a lens module includes a lens formed of a first material, and a lens barrel formed of a second material, different from the first material, and including an accommodation space accommodating the lens. A protrusion protruding toward an outer circumferential surface of the lens is disposed in the accommodation space, and conditional expression 0.3<G/X<0.8 is satisfied, where G is a distance between an end of the protrusion and the outer circumferential surface of the lens, and X is a maximum expansion deformation amount of the lens.

The protrusion may have a cross-sectional area decreasing toward an optical axis of the lens from an inner circumferential surface of the lens barrel.

The protrusion may include a first extension having a first cross-sectional shape, and a second extension having a second cross-sectional shape.

The first cross-sectional shape may be rectangular and the second cross-sectional shape may be triangular.

The protrusion may include protrusions disposed at predetermined distances along an inner circumferential surface of the lens barrel.

The protrusion may be disposed annularly along an inner circumferential surface of the lens barrel.

The first material may have a lower strength than the second material.

The accommodation space may include a cross-sectional area gradually decreasing from one end of the lens barrel toward the other end.

In another general aspect, a lens module includes a lens, a lens barrel accommodating the lens, and a support member disposed between the lens and the lens barrel, wherein the support member includes a first protrusion protruding toward an outer circumferential surface of the lens, and wherein conditional expression 0.3<G1/X<0.8 is satisfied, where G1 is a distance between an end of the first protrusion and the outer circumferential surface of the lens, and X is a maximum expansion deformation amount of the lens.

A step supporting the support member may be disposed on an inner circumferential surface of the lens barrel.

The first protrusion may include protrusions disposed at predetermined distances along a circumferential direction of the support member.

The first protrusion may have a cross-sectional area decreasing away from the support member.

The first protrusion may include a first extension having a first cross-sectional shape, and a second extension having a second cross-sectional shape.

The first cross-sectional shape may be rectangular and the second cross-sectional shape may be triangular.

The support member may further include a second protrusion protruding toward an inner circumferential surface of the lens barrel.

The first protrusion and the second protrusion may be alternately disposed along a circumferential direction of the support member.

Other features and aspects will be apparent from the following detailed description, the drawings, and the claims.

### BRIEF DESCRIPTION OF DRAWINGS&

FIG. 1 is a configuration diagram of a lens module according to a first example embodiment of the present disclosure.

FIG. 2 is an enlarged view of portion A illustrated in FIG. 1.

FIG. 3 is an enlarged view of portion A deformed by high temperature.

FIG. 4 is a cross-sectional view taken along line I-I according to one example.

FIG. 5 is a cross-sectional view taken along line I-I according to another example.

FIG. 6 illustrates a first modified example of a protrusion illustrated in FIG. 2.

FIG. 7 illustrates a second modified example of the protrusion illustrated in FIG. 2.

FIG. 8 is a configuration diagram of a lens module according to a second example embodiment of the present disclosure.

FIG. 9 is an enlarged view of portion B illustrated in FIG. 8.

FIG. 10 is an enlarged view of portion B deformed by high temperature.

FIG. 11 is a cross-sectional view taken along line II-II according to one example.

FIG. 12 is a cross-sectional view taken along line II-II according to another example.

FIG. 13 illustrates a first modified example of a first protrusion illustrated in FIG. 9.

FIG. 14 illustrates a second modified example of a second protrusion illustrated in FIG. 9.

FIG. 15 is a configuration diagram of a lens module according to a third example embodiment of the present disclosure.

FIG. 16 is an enlarged view of portion C illustrated in FIG. 15.

FIG. 17 is an enlarged view of portion C deformed by high temperature.

FIG. 18 is a cross-sectional view taken along line III-III according to one example.

FIG. 19 is a cross-sectional view taken along line III-III according to another example.

FIG. 20 illustrates a first modified example of a first protrusion illustrated in FIG. 16.

FIG. 21 illustrates a second modified example of a second protrusion illustrated in FIG. 16.

Throughout the drawings and the detailed description, unless otherwise described, the same reference numerals refer to the same elements. The drawings may not be to scale, and the relative size, proportions, and depiction of elements in the drawings may be exaggerated for clarity, illustration, and convenience.

### DETAILED DESCRIPTION

Hereinafter, while examples of the present disclosure will be described in detail with reference to the accompanying drawings, it is noted that examples are not limited to the same.

The following detailed description is provided to assist the reader in gaining a comprehensive understanding of the methods, apparatuses, and/or systems described herein. However, various changes, modifications, and equivalents of the methods, apparatuses, and/or systems described herein will be apparent after an understanding of this disclosure. For example, the sequences of operations described herein are merely examples, and are not limited to those set forth herein, but may be changed as will be apparent after an understanding of this disclosure, with the exception of operations necessarily occurring in a certain order. Also, descriptions of features that are known in the art may be omitted for increased clarity and conciseness.

The features described herein may be embodied in different forms, and are not to be construed as being limited to the examples described herein. Rather, the examples described herein have been provided merely to illustrate some of the many possible ways of implementing the methods, apparatuses, and/or systems described herein that will be apparent after an understanding of this disclosure.

Throughout the specification, when an element, such as a layer, region, or substrate is described as being “on,” “connected to,” or “coupled to” another element, it may be directly “on,” “connected to,” or “coupled to” the other element, or there may be one or more other elements intervening therebetween. In contrast, when an element is described as being “directly on,” “directly connected to,” or “directly coupled to” another element, there can be no other elements intervening therebetween.

As used herein, the term “and/or” includes any one and any combination of any two or more of the associated listed items; likewise, “at least one of” includes any one and any combination of any two or more of the associated listed items.

Although terms such as “first,” “second,” and “third” may be used herein to describe various members, components, regions, layers, or sections, these members, components, regions, layers, or sections are not to be limited by these terms. Rather, these terms are only used to distinguish one member, component, region, layer, or section from another member, component, region, layer, or section. Thus, a first member, component, region, layer, or section referred to in examples described herein may also be referred to as a second member, component, region, layer, or section without departing from the teachings of the examples.

Spatially relative terms, such as “above,” “upper,” “below,” “lower,” and the like, may be used herein for ease of description to describe one element's relationship to another element as shown in the figures. Such spatially relative terms are intended to encompass different orientations of the device in use or operation in addition to the orientation depicted in the figures. For example, if the device in the figures is turned over, an element described as being “above,” or “upper” relative to another element would then be “below,” or “lower” relative to the other element. Thus, the term “above” encompasses both the above and below orientations depending on the spatial orientation of the device. The device may also be oriented in other ways (rotated 90 degrees or at other orientations), and the spatially relative terms used herein are to be interpreted accordingly.

The terminology used herein is for describing various examples only, and is not to be used to limit the disclosure. The articles “a,” “an,” and “the” are intended to include the plural forms as well, unless the context clearly indicates otherwise. The terms “comprises,” “includes,” and “has” specify the presence of stated features, numbers, operations, members, elements, and/or combinations thereof, but do not preclude the presence or addition of one or more other features, numbers, operations, members, elements, and/or combinations thereof.

Due to manufacturing techniques and/or tolerances, variations of the shapes shown in the drawings may occur. Thus, the examples described herein are not limited to the specific shapes shown in the drawings, but include changes in shape that occur during manufacturing.

Herein, it is noted that use of the term “may” with respect to an example, for example, as to what an example may include or implement, means that at least one example exists in which such a feature is included or implemented while all examples are not limited thereto.

The features of the examples described herein may be combined in various ways as will be apparent after an understanding of this disclosure. Further, although the examples described herein have a variety of configurations, other configurations are possible as will be apparent after an understanding of this disclosure.

An aspect of the present disclosure is to provide a lens module enabling alignment of optical axes of lenses while minimizing breakage or distortion of the lenses caused by expansion variation in the lenses.

A lens module according to the present disclosure may be mounted in an electronic device. For example, the lens module may be mounted in a portable terminal, a laptop computer, a virtual reality (VR) device, glasses, or the like. However, the electronic device in which the lens module may be mounted is not limited to the above-described devices. For example, the lens module may be mounted in any portable electronic device such as a portable game console.

A lens module according to a first aspect of the present disclosure may include a lens and a lens barrel. The lens may have refractive power, and the lens barrel may include an accommodation space for accommodating the lens. In the lens module according to this aspect, the lens and the lens barrel may be made of different materials. For example, the lens may be made of a first material, and the lens barrel may be made of a second material, different from the first material. The lens module according to this aspect may relieve or absorb expansion stress of the lens. For example, the lens barrel according to this aspect may include a protrusion protruding toward an outer circumferential surface of the lens. The protrusion may relieve or absorb expansion stress of the lens by minimizing a physical contact area between the lens and the lens barrel. The lens module according to this aspect may satisfy a specific conditional expression. For example, in the lens module according to this aspect, a distance G between an end of the protrusion and the outer circumferential surface of the lens may satisfy the following conditional expression in relation to the maximum expansion deformation amount X of the lens: 0.3<G/X<0.8.

A lens module according to a second aspect of the present disclosure may include a lens, a lens barrel, and a support member. The lens may have refractive power, the lens barrel may include an accommodation space for accommodating the lens, and the support member may be disposed between the lens and the lens barrel. The lens module according to this aspect may relieve or absorb expansion stress of the lens. For example, the support member according to this aspect may include a first protrusion protruding toward an outer circumferential surface of the lens. The first protrusion may relieve or absorb expansion stress of the lens by minimizing a physical contact area between the lens and the support member. The lens module according to this aspect may satisfy a unique conditional expression. For example, in the lens module according to this aspect, a distance G1 between an end of the first protrusion and the outer circumferential surface of the lens may satisfy the following conditional expression with respect to the maximum expansion deformation amount X of the lens: 0.3<G1/X<0.8.

In addition, in the lens module according to this aspect, the lens, the lens barrel, and the support member may be made of different materials. For example, the lens may be made of a first material, and the lens barrel and the support member may be made of a second material, different from the first material. However, it is not necessary that the lens, the lens barrel, and the support member be necessarily made of different materials.

Hereinafter, lens modules according to various example embodiments of the present disclosure are described with reference to the accompanying drawings.

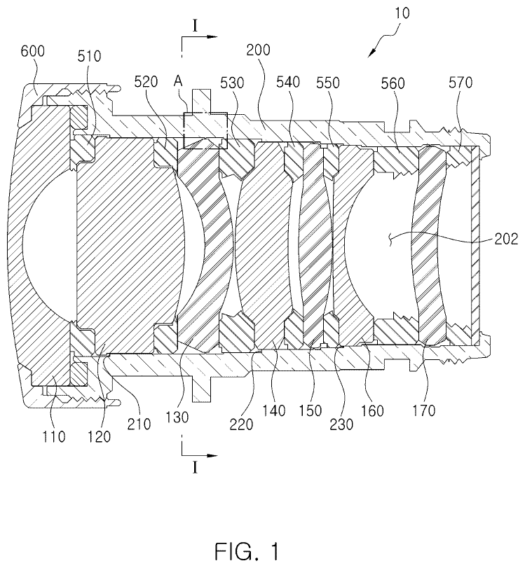

First, a lens module according to a first example embodiment is described with reference to FIGS. 1 through 7.

A lens module 10 according to this example embodiment may include lenses 110, 120, 130, 140, 150, 160, and 170 and a lens barrel 200. However, the configuration of the lens module 10 is not limited to the lenses 110, 120, 130, 140, 150, 160, and 170 and the lens barrel 200. For example, the lens module 10 may further include spacers 510, 520, 530, 540, 550, 560, and 570 and a cover member 600.

The lenses 110, 120, 130, 140, 150, 160, and 170 may be made of different materials. For example, among the lenses 110, 120, 130, 140, 150, 160, and 170, some may be made of glass and the others may be made of plastic. In a specific example, a first lens 110, the second lens 120, the fourth lens 140, and the sixth lens 160 may be made of glass, and the third lens 130, the fifth lens 150, and the seventh lens 170 may be made of plastic. However, the materials of the lenses are not limited to the above-described materials.

The lenses 110, 120, 130, 140, 150, 160, and 170 may have refractive power. For example, the lenses 110, 120, 130, 140, 150, 160, and 170 may have positive or negative refractive power. One surface of each of the lenses 110, 120, 130, 140, 150, 160, and 170 may be convex or concave. For example, the first lens 110 may have a convex object-side surface and a concave image-side surface.

The lenses 110, 120, 130, 140, 150, 160, and 170 may be sequentially arranged at predetermined distances along an optical axis direction. For example, the first lens 110, the second lens 120, the third lens 130, the fourth lens 140, the fifth lens 150, the sixth lens 160, and the seventh lens 170 may be sequentially arranged at predetermined distances from the object-side surface toward the image-side surface (or an image sensor).

The lenses 110, 120, 130, 140, 150, 160, and 170 may have different sizes. For example, sizes (or the maximum diameters) of the lenses 110, 120, 130, 140, 150, 160, and 170 may gradually decrease from the object-side surface toward the image-side surface. Specifically, the maximum diameter of the first lens 110 may be greater than that of the second lens 120, and the maximum diameter of the second lens 120 may be greater than that of the third lens 130.

The lens barrel 200 may accommodate a plurality of lenses. For example, the lenses 110, 120, 130, 140, 150, 160, and 170 may be accommodated in an internal accommodation space 202 of the lens barrel 200. The lens barrel 200 may accommodate lenses 110, 120, 130, 140, 150, 160, and 170 having different sizes. In an example, a plurality of steps 210, 220, and 230 may be formed in the accommodation space 202 of the lens barrel 200. Each step 210, 220, and 230 may serve as a support structure for fixing positions of some of the lenses 110, 120, 130, 140, 150, 160, and 170.

The lens barrel 200 may be made of a material different from that of the lenses 110, 120, 130, 140, 150, 160, and 170. In an example, the lens barrel 200 may be made of a metallic material. In another example, a thermal-expansion variation rate of the lens barrel 200 may differ from that of the lenses 110, 120, 130, 140, 150, 160, and 170. Specifically, the thermal-expansion variation rate of the lens barrel 200 may be lower than the maximum thermal-expansion variation rate of the lenses 110, 120, 130, 140, 150, 160, and 170.

The spacers 510, 520, 530, 540, 550, 560, and 570 may be disposed between the lenses 110, 120, 130, 140, 150, 160, and 170. For example, the first spacer 510 may be disposed between the first lens 110 and the second lens 120, the second spacer 520 may be disposed between the second lens 120 and the third lens 130, the third spacer 530 may be disposed between the third lens 130 and the fourth lens 140, the fourth spacer 540 may be disposed between the fourth lens 140 and the fifth lens 150, the fifth spacer 550 may be disposed between the fifth lens 150 and the sixth lens 160, and the sixth spacer 560 may be disposed between the sixth lens 160 and the seventh lens 170. The seventh spacer 570 may be disposed between the seventh lens 170 and protective glass, or may be disposed on the image-side surface of the seventh lens 170 as a press-fit ring for fixing a position of the seventh lens 170.

A cover member 600 may fix the first lens 110 to the lens barrel 200. Specifically, the cover member 600 may be screwed to the lens barrel 200 while being in contact with an outer circumferential surface of the first lens 110 to prevent the first lens 110 from being separated from the lens barrel 200.

Some of the plurality of lenses 110, 120, 130, 140, 150, 160, and 170 may expand in a direction intersecting the optical axis (or a radial direction of the lens) due to a temperature change in an external environment (herein referred to as expansion deformation). For example, the plastic lenses 130, 150, and 170 may expand in a high-temperature environment (80° C. or higher). However, the lens barrel 200 having higher rigidity and strength than the lenses 130, 150, and 170 may suppress expansion deformation of the lenses 130, 150, and 170. Accordingly, the lenses 130, 150, and 170 may be deformed or broken due to expansion stress, significantly degrading optical performance of the lens module 10.

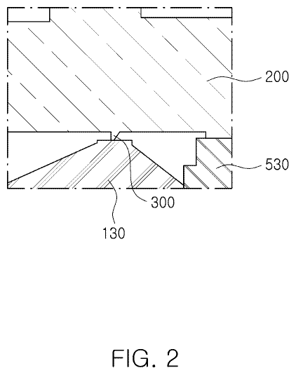

The lens module 10 according to this example embodiment may further include a component for addressing the above issue. For example, the lens barrel 200 according to this example embodiment may further include a protrusion 300 as illustrated in FIG. 2.

The protrusion 300 may be disposed in the accommodation space 202 of the lens barrel 200. Specifically, the protrusion 300 may protrude from an inner circumferential surface of the lens barrel 200 toward outer circumferential surfaces of the lenses 130, 150, and 170. The protrusion 300 may have a cross-sectional area decreasing from one end toward a distal end. For example, the distal end of the protrusion 300 may be substantially pointed to minimize contact areas with the lenses 130, 150, and 170.

The protrusion 300 may be substantially formed not to be in contact with the outer circumferential surfaces of the lenses 130, 150, and 170. For example, a predetermined distance G may be formed between the end of the protrusion 300 and the outer circumferential surfaces of the lenses 130, 150, and 170. The distance G may have a specific relation with the maximum expansion deformation amount X of the lenses 130, 150, and 170. For example, the distance G may satisfy the following conditional expression in relation to the maximum expansion deformation amount X of the lenses 130, 150, and 170: 0.3<G/X<0.8.

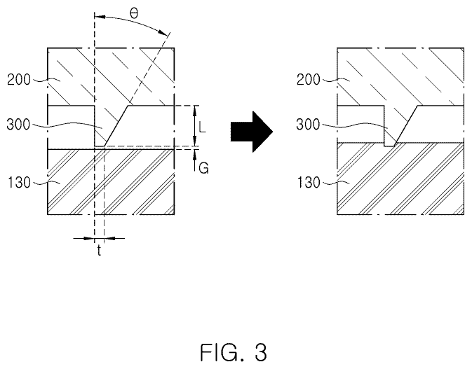

However, the end of the protrusion 300 and the outer circumferential surfaces of the lenses 130, 150, and 170 are not maintained in a non-contact state. For example, the protrusion 300 may be inserted into ribs of the lenses 130, 150, and 170 upon expansion deformation of the lenses 130, 150, and 170 (see FIG. 3). To this end, the protrusion 300 may have a predetermined length L and may be made of a material having rigidity and strength greater than those of the lenses 130, 150, and 170. The length L of the protrusion 300 may have a predetermined relation with an expansion deformation amount of the lenses 130, 150, and 170. For example, the length L of the protrusion 300 may be greater than the expansion deformation amount of the lenses 130, 150, and 170. In an example, the length L of the protrusion 300 may be 0.1 mm or more. The protrusion 300 may be formed to substantially coincide with half points of the lenses 130, 150, and 170 in the optical axis direction. Specifically, the protrusion 300 may be formed to coincide with a half point of a line segment connecting the object-side surface and image-side surface of each of the lenses 130, 150, and 170 (that is, a thickness of the lens). An end thickness t of the protrusion 300 and the length L of the protrusion 300 may have a predetermined proportional relation. For example, the end thickness t of the protrusion 300 may be smaller than 1/20 of the length L of the protrusion 300. The end of the protrusion 300 may be pointed as described above. In a specific example, an angle θ formed between a flat surface and inclined surface of the protrusion 300 may be 30 degrees or less.

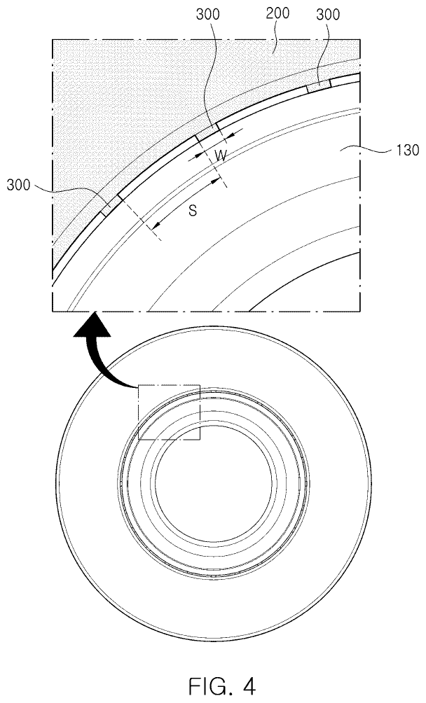

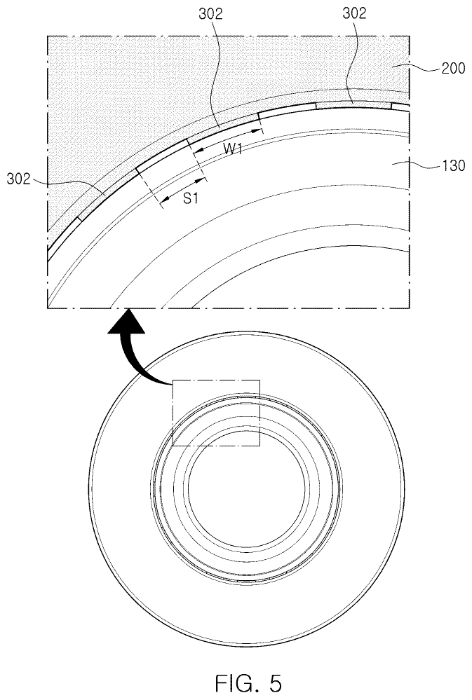

As illustrated in FIGS. 4 and 5, protrusions 300 and 302 may be disposed at predetermined distances along a circumferential direction of the lens barrel 200. In an example, the protrusions 300 may be formed along the circumferential direction of the lens barrel 200 at a distance S wider than a width W of the protrusions 300. In another example, the protrusions 302 may be formed along the circumferential direction of the lens barrel 200 at a distance S1 narrower than a width W1 of the protrusions 302. The former form may be advantageous for supporting thin lenses 130, 150, and 170, and the latter form may be advantageous for supporting thick lenses 130, 150, and 170. However, use examples of the protrusions 300 and 302 are not limited to the forms of the lenses 130, 150, and 170 described above. In addition, although FIGS. 4 and 5 illustrate that the protrusions 300 and 302 are formed at the predetermined distances along the inner circumferential surface of the lens barrel 200, the protrusions 300 and 302 may be formed annularly along the inner circumferential surface of the lens barrel 200 as needed.

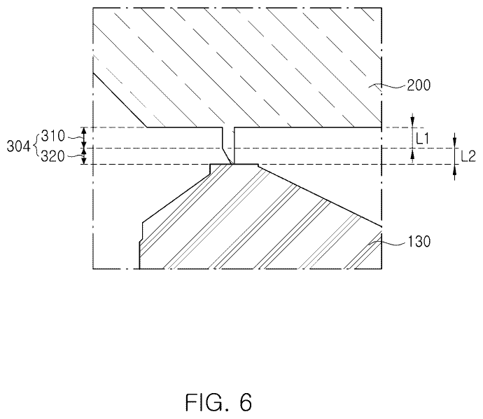

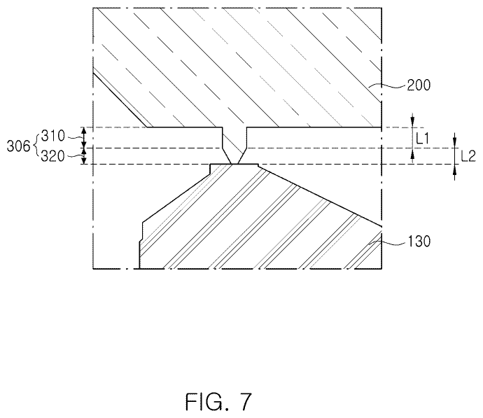

A protrusion having another form is described with reference to FIGS. 6 and 7.

Protrusions 304 and 306 may include two extensions 310 and 320 having different cross-sectional areas as illustrated in FIGS. 6 and 7. For example, the protrusions 304 and 306 may include a first extension 310 having a constant cross-sectional area and a second extension 320 having a gradually reduced cross-sectional area. Specifically, the first extension 310 may have a substantially rectangular cross-sectional shape, and the second extension 320 may have a substantially triangular cross-sectional shape. The cross-sectional shape of the second extension 320 may be a right triangle as illustrated in FIG. 6 or an isosceles triangle as illustrated in FIG. 7. The first extension 310 and the second extension 320 may have predetermined lengths. For example, the first extension 310 may have a first length L1, and the second extension 320 may have a second length L2. The first extension 310 and the second extension 320 may have different lengths. For example, the first length L1 may be greater than the second length L2. However, the first length L1 is not necessarily greater than the second length L2. In an example, the first length L1 may have the same size as the second length L2.

The lens module 10 configured as described above may relieve internal stress caused by the expansion deformation of the lenses 130, 150, and 170 or minimize plastic deformation of the lenses 130, 150, and 170 by using the protrusions 300 (302 and 304) formed on the lens barrel 200.

Tables 1 and 2 show the internal stress and plastic deformation amount, respectively, of the third lens 130 based on the expansion amount of the third lens 130. In Table 1, a comparative example shows a structure in which the third lens 130 and the lens barrel 200 are in surface contact with each other, and an example embodiment according to the present disclosure shows a structure in which the third lens 130 and the lens barrel 200 are in contact with each other by using the protrusion 300. In addition, a first surface refers to the object-side surface of the third lens 130 (a surface close to an object), and a second surface refers to an image-side surface of the third lens 130 (a surface close to an image). The third lens 130 may expand from 0 micrometers (μm) to 15 μm (based on an optical-axis deformation amount) when heated from room temperature (25° C.) to a high temperature (110° C.). Accordingly, the third lens 130 may experience an increase in the internal stress in proportion to the expansion deformation amount and may be partially plastically deformed.

TABLE 1

| Remarks (Third Lens) | | 0 μm | 5 μm | 10 μm | 15 μm |
|---|---|---|---|---|---|
| Comparative | First Surface | 0.2779 | 0.7629 | 2.8495 | 5.9319 |
| Example | Second | 0.3426 | 0.7873 | 3.9198 | 7.2218 |
| | Surface | | | | |
| Example | First Surface | 0.2779 | 0.5742 | 1.9932 | 3.5496 |
| Embodiment | Second | 0.3426 | 0.6085 | 2.4760 | 3.3126 |
| of the Present | Surface | | | | |
| Disclosure | | | | | |

TABLE 2

| Remarks (Third Lens) | | 0 μm | 5 μm | 10 μm | 15 μm |
|---|---|---|---|---|---|
| Comparative | First Surface | 0 | 0.383 | 0.537 | 5.437 |
| Example | Second | 0 | 0.306 | 0.329 | 2.939 |
| | Surface | | | | |
| Example | First Surface | 0 | 0.341 | 0.506 | 1.612 |
| Embodiment | Second | 0 | 0.273 | 0.312 | 1.058 |
| of the Present | Surface | | | | |
| Disclosure | | | | | |

As seen from Tables 1 and 2, in the comparative example, the internal stress and plastic deformation amount of the third lens 130 significantly increases as the expansion deformation amount of the third lens 130 increases. In contrast, in the example embodiment according to the present disclosure, even when the expansion deformation amount of the third lens 130 increases, the internal stress and plastic deformation amount decreases to about 29% to 60% of those of the comparative example. Therefore, use of the lens module 10 according to this example embodiment may improve optical performance and resolution of a camera module exposed to or easily exposed to the external environment.

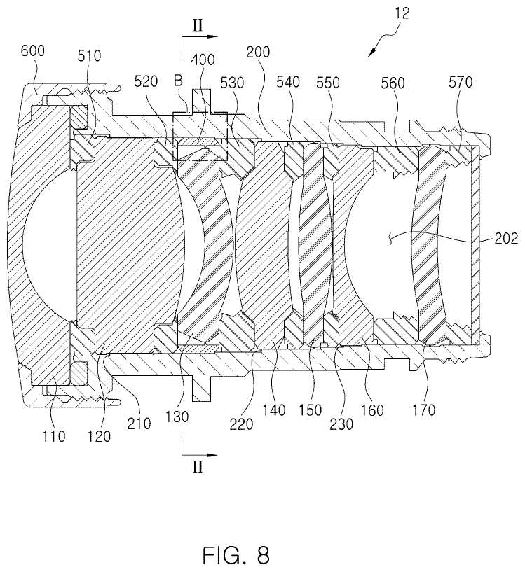

Next, a lens module according to a second example embodiment is described with reference to FIGS. 8 through 14.

A lens module 12 according to this example embodiment may include lenses 110, 120, 130, 140, 150, 160, and 170 and a lens barrel 200. However, the configuration of the lens module 12 is not limited to the lenses 110, 120, 130, 140, 150, 160, and 170 and the lens barrel 200. For example, the lens module 12 may further include spacers 510, 520, 530, 540, 550, 560, and 570 and a cover member 600.

The lenses 110, 120, 130, 140, 150, 160, and 170 may be made of different materials. For example, among the lenses 110, 120, 130, 140, 150, 160, and 170, some may be made of glass and the others may be made of plastic. In a specific example, the first lens 110, the second lens 120, the fourth lens 140, and the sixth lens 160 may be made of glass, and the third lens 130, the fifth lens 150, and the seventh lens 170 may be made of plastic. However, the materials of the lenses are not limited to the above-described materials.

The lenses 110, 120, 130, 140, 150, 160, and 170 may have refractive power. For example, the lenses 110, 120, 130, 140, 150, 160, and 170 may have positive or negative refractive power. One surface of each of the lenses 110, 120, 130, 140, 150, 160, and 170 may be convex or concave. For example, the first lens 110 may have a convex object-side surface and a concave image-side surface.

The lenses 110, 120, 130, 140, 150, 160, and 170 may be sequentially arranged at predetermined distances along an optical axis direction. For example, the first lens 110, the second lens 120, the third lens 130, the fourth lens 140, the fifth lens 150, the sixth lens 160, and the seventh lens 170 may be sequentially arranged at predetermined distances from the object-side surface toward the image-side surface (or an image sensor).

The lenses 110, 120, 130, 140, 150, 160, and 170 may have different sizes. For example, sizes (or the maximum diameters) of the lenses 110, 120, 130, 140, 150, 160, and 170 may gradually decrease from the object-side surface toward the image-side surface. Specifically, the maximum diameter of the first lens 110 may be greater than that of the second lens 120, and the maximum diameter of the second lens 120 may be greater than that of the third lens 130.

The lens barrel 200 may accommodate a plurality of lenses. For example, the lenses 110, 120, 130, 140, 150, 160, and 170 may be accommodated in an internal accommodation space 202 of the lens barrel 200. The lens barrel 200 may accommodate lenses 110, 120, 130, 140, 150, 160, and 170 having different sizes. In an example, the accommodation space 202 of the lens barrel 200 may have a cross-sectional area gradually decreasing from one end to the other end of the lens barrel. In another example, the plurality of steps 210, 220, and 230 may be formed in the accommodation space 202 of the lens barrel 200. Each step 210, 220, and 230 may serve as a support structure for fixing positions of some of the lenses 110, 120, 130, 140, 150, 160, and 170 and a support member 400.

The lens barrel 200 may be made of a material different from that of the lenses 110, 120, 130, 140, 150, 160, and 170. In an example, the lens barrel 200 may be made of a metallic material. In another example, a thermal-expansion variation rate of the lens barrel 200 may differ from that of the lenses 110, 120, 130, 140, 150, 160, and 170. Specifically, the thermal-expansion variation rate of the lens barrel 200 may be lower than the maximum thermal-expansion variation rate of the lenses 110, 120, 130, 140, 150, 160, and 170.

The spacers 510, 520, 530, 540, 550, 560, and 570 may be disposed between the lenses 110, 120, 130, 140, 150, 160, and 170. For example, the first spacer 510 may be disposed between the first lens 110 and the second lens 120, the second spacer 520 may be disposed between the second lens 120 and the third lens 130, the third spacer 530 may be disposed between the third lens 130 and the fourth lens 140, the fourth spacer 540 may be disposed between the fourth lens 140 and the fifth lens 150, the fifth spacer 550 may be disposed between the fifth lens 150 and the sixth lens 160, and the sixth spacer 560 may be disposed between the sixth lens 160 and the seventh lens 170. The seventh spacer 570 may be disposed between the seventh lens 170 and protective glass, or may be disposed on the image-side surface of the seventh lens 170 as a press-fit ring for fixing a position of the seventh lens 170.

A cover member 600 may fix the first lens 110 to the lens barrel 200. Specifically, the cover member 600 may be screwed to the lens barrel 200 while being in contact with an outer circumferential surface of the first lens 110 to prevent the first lens 110 from being separated from the lens barrel 200.

Some of the plurality of lenses 110, 120, 130, 140, 150, 160, and 170 may expand in a direction intersecting the optical axis (or a radial direction of the lens) due to a temperature change in an external environment. For example, the plastic lenses 130, 150, and 170 may expand in a high-temperature environment (80° C. or higher). However, the lens barrel 200 having higher rigidity and strength than the lenses 130, 150, and 170 may suppress expansion deformation of the lenses 130, 150, and 170. Accordingly, the lenses 130, 150, and 170 may be deformed or broken due to expansion stress, significantly degrading optical performance of the lens module 12.

The lens module 12 according to this example embodiment may further include a configuration for addressing the above issue. For example, the lens barrel 200 according to this example embodiment may further include the support member 400 as illustrated in FIG. 8.

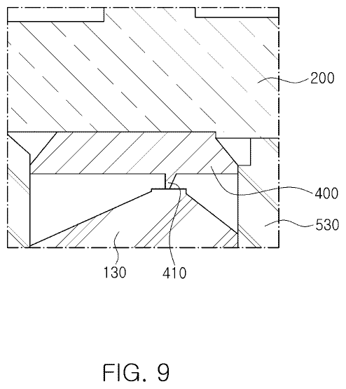

As illustrated in FIG. 9, the support member 400 may include a protrusion 410 for minimizing a contact area with the lenses 130, 150, and 170. The protrusion 410 may protrude from an inner circumferential surface of the support member 400 toward outer circumferential surfaces of the lenses 130, 150, and 170. The protrusion 410 may have a cross-sectional area decreasing from one end toward a distal end. For example, the distal end of the protrusion 410 may be substantially pointed to minimize contact areas with the lenses 130, 150, and 170.

The protrusion 410 may be substantially formed not to be in contact with the outer circumferential surfaces of the lenses 130, 150, and 170. For example, a predetermined distance G1 may be formed between the end of the protrusion 410 and the outer circumferential surfaces of the lenses 130, 150, and 170. The distance G1 may have a specific relation with the maximum expansion deformation amount X of the lenses 130, 150, and 170. For example, the distance G1 may satisfy the following conditional expression in relation to the maximum expansion deformation amount X of the lenses 130, 150, and 170: 0.3<G1/X<0.8.

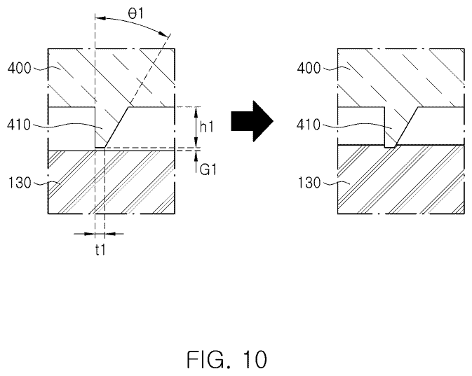

However, the end of the protrusion 410 and the outer circumferential surfaces of the lenses 130, 150, and 170 are not maintained in a non-contact state. For example, the protrusion 410 may be inserted into ribs of the lenses 130, 150, and 170 upon expansion deformation of the lenses 130, 150, and 170 (see FIG. 10). To this end, the protrusion 410 may have a predetermined length h1 and may be made of a material having rigidity and strength greater than those of the lenses 130, 150, and 170. The length h1 of the protrusion 410 may have a predetermined relation with an expansion deformation amount of the lenses 130, 150, and 170. For example, the length h1 of the protrusion 410 may be greater than the expansion deformation amount of the lenses 130, 150, and 170. In an example, the length h1 of the protrusion 410 may be 0.1 mm or more. The protrusion 410 may be formed to substantially coincide with half points of the lenses 130, 150, and 170 in the optical axis direction. Specifically, the protrusion 410 may be formed to coincide with a half point of a line segment connecting the object-side surface and image-side surface of each of the lenses 130, 150, and 170 (that is, a thickness of the lens). An end thickness t1 of the protrusion 410 and the length h1 of the protrusion 410 may have a predetermined proportional relation. For example, the end thickness t1 of the protrusion 410 may be smaller than 1/20 of the length h1 of the protrusion 410. The end of the protrusion 410 may be pointed as described above. In a specific example, an angle θ1 formed between the flat surface and inclined surface of the protrusion 410 may be 30 degrees or less.

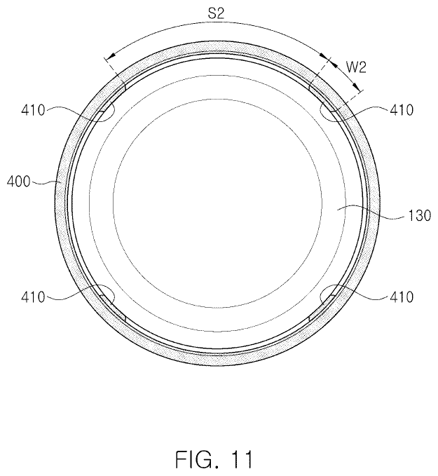

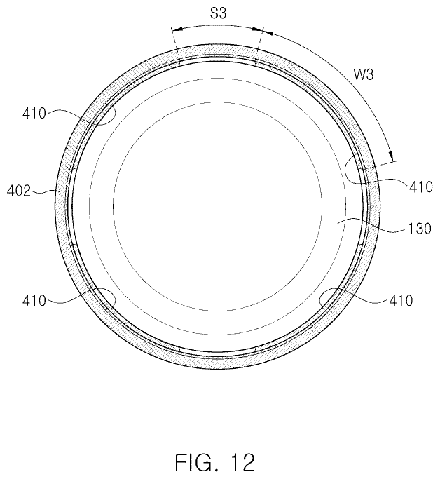

As illustrated in FIGS. 11 and 12, the protrusions 410 may be disposed at predetermined distances along a circumferential direction of the support members 400 and 402. In an example, the protrusion 410 may be formed along the circumferential direction of the support member 400 at a distance S2 wider than a width W2 of the protrusion 410. In another example, the protrusion 410 may be formed along the circumferential direction of the support member 402 at a distance S3 narrower than a width W3 of the protrusion 410. The former form may be advantageous for supporting thin lenses 130, 150, and 170, and the latter form may be advantageous for supporting thick lenses 130, 150, and 170. However, use examples of the support members 400 and 402 are not limited to the forms of the lenses 130, 150, and 170 described above. In addition, although FIGS. 11 and 12 illustrate that the protrusions 410 are formed at the predetermined distances along the inner circumferential surfaces of the support members 400 and 402, the protrusion 410 be formed annularly along the inner circumferential surface of the support members 400 and 402 as needed.

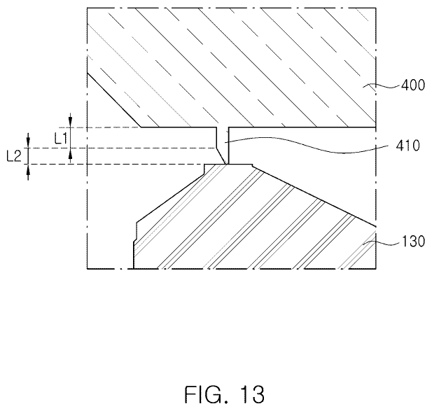

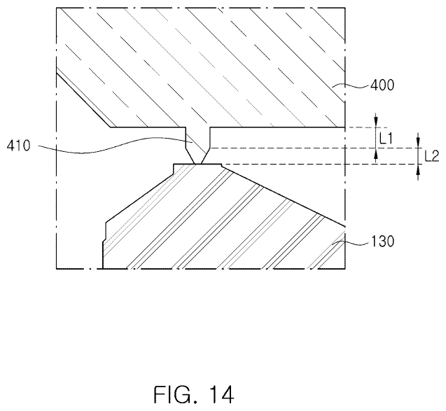

A protrusion having another form is described with reference to FIGS. 13 and 14.

The protrusion 410 may include two extensions 310 and 320 having different cross-sectional areas as illustrated in FIGS. 13 and 14. For example, the protrusion 410 may include a first extension 310 having a constant cross-sectional area and a second extension 320 having a gradually reduced cross-sectional area. Specifically, the first extension 310 may have a substantially rectangular cross-sectional shape, and the second extension 320 may have a substantially triangular cross-sectional shape. The cross-sectional shape of the second extension 320 may be a right triangle as illustrated in FIG. 13 or an isosceles triangle as illustrated in FIG. 14. The first extension 310 and the second extension 320 may have predetermined lengths. For example, the first extension 310 may have a first length L1, and the second extension 320 may have a second length L2. The first extension 310 and the second extension 320 may have different lengths. For example, the first length L1 may be greater than the second length L2. However, the first length L1 is not necessarily greater than the second length L2. In an example, the first length L1 may have the same size as the second length L2.

The lens module 12 configured as described above may relieve internal stress caused by the expansion deformation of the lenses 130, 150, and 170 or minimize plastic deformation of the lenses 130, 150, and 170 by using the protrusion 410 formed on the support members 400 and 402.

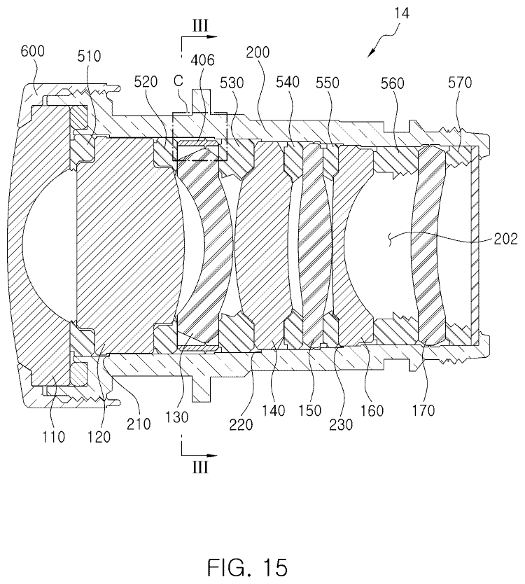

Next, a lens module according to a third example embodiment is described with reference to FIGS. 15 through 21.

A lens module 14 according to this example embodiment may include lenses 110, 120, 130, 140, 150, 160, and 170 and a lens barrel 200. However, the configuration of the lens module 14 is not limited to the lenses 110, 120, 130, 140, 150, 160, and 170 and the lens barrel 200. For example, the lens module 14 may further include spacers 510, 520, 530, 540, 550, 560, and 570 and a cover member 600.

The lenses 110, 120, 130, 140, 150, 160, and 170 may be made of different materials. For example, among the lenses 110, 120, 130, 140, 150, 160, and 170, some may be made of glass and the others may be made of plastic. In a specific example, the first lens 110, the second lens 120, the fourth lens 140, and the sixth lens 160 may be made of glass, and the third lens 130, the fifth lens 150, and the seventh lens 170 may be made of plastic. However, the materials of the lenses are not limited to the above-described materials.

The lenses 110, 120, 130, 140, 150, 160, and 170 may have refractive power. For example, the lenses 110, 120, 130, 140, 150, 160, and 170 may have positive or negative refractive power. One surface of each of the lenses 110, 120, 130, 140, 150, 160, and 170 may be convex or concave. For example, the first lens 110 may have a convex object-side surface and a concave image-side surface.

The lenses 110, 120, 130, 140, 150, 160, and 170 may be sequentially arranged at predetermined distances along an optical axis direction. For example, the first lens 110, the second lens 120, the third lens 130, the fourth lens 140, the fifth lens 150, the sixth lens 160, and the seventh lens 170 may be sequentially arranged at predetermined distances from the object-side surface toward the image-side surface (or an image sensor).

The lenses 110, 120, 130, 140, 150, 160, and 170 may have different sizes. For example, sizes (or the maximum diameters) of the lenses 110, 120, 130, 140, 150, 160, and 170 may gradually decrease from the object-side surface toward the image-side surface. Specifically, the maximum diameter of the first lens 110 may be greater than that of the second lens 120, and the maximum diameter of the second lens 120 may be greater than that of the third lens 130.

The lens barrel 200 may accommodate a plurality of lenses. For example, the lenses 110, 120, 130, 140, 150, 160, and 170 may be accommodated in an internal accommodation space 202 of the lens barrel 200. The lens barrel 200 may accommodate lenses 110, 120, 130, 140, 150, 160, and 170 having different sizes. In an example, the accommodation space 202 of the lens barrel 200 may have a shape in which a cross-sectional area gradually decreases from one end to the other end of the lens barrel. In another example, a plurality of steps 210, 220, and 230 may be formed in the accommodation space 202 of the lens barrel 200. Each step 210, 220, and 230 may serve as a support structure for fixing positions of some of the lenses 110, 120, 130, 140, 150, 160, and 170 and a support member 406.

The lens barrel 200 may be made of a material different from that of the lenses 110, 120, 130, 140, 150, 160, and 170. In an example, the lens barrel 200 may be made of a metallic material. In another example, a thermal-expansion variation rate of the lens barrel 200 may differ from that of the lenses 110, 120, 130, 140, 150, 160, and 170. Specifically, the thermal-expansion variation rate of the lens barrel 200 may be lower than the maximum thermal-expansion variation rate of the lenses 110, 120, 130, 140, 150, 160, and 170.

The spacers 510, 520, 530, 540, 550, 560, and 570 may be disposed between the lenses 110, 120, 130, 140, 150, 160, and 170. For example, the first spacer 510 may be disposed between the first lens 110 and the second lens 120, the second spacer 520 may be disposed between the second lens 120 and the third lens 130, the third spacer 530 may be disposed between the third lens 130 and the fourth lens 140, the fourth spacer 540 may be disposed between the fourth lens 140 and the fifth lens 150, the fifth spacer 550 may be disposed between the fifth lens 150 and the sixth lens 160, and the sixth spacer 560 may be disposed between the sixth lens 160 and the seventh lens 170. The seventh spacer 570 may be disposed between the seventh lens 170 and protective glass, or may be disposed on the image-side surface of the seventh lens 170 as a press-fit ring for fixing a position of the seventh lens 170.

A cover member 600 may fix the first lens 110 to the lens barrel 200. Specifically, the cover member 600 may be screwed to the lens barrel 200 while being in contact with an outer circumferential surface of the first lens 110 to prevent the first lens 110 from being separated from the lens barrel 200.

Some of the plurality of lenses 110, 120, 130, 140, 150, 160, and 170 may expand in a direction intersecting the optical axis (a radial direction of the lens) due to a temperature change in an external environment. For example, the plastic lenses 130, 150, and 170 may expand in a high-temperature environment (80° C. or higher). However, the lens barrel 200 having higher rigidity and strength than the lenses 130, 150, and 170 may suppress expansion deformation of the lenses 130, 150, and 170. Accordingly, the lenses 130, 150, and 170 may be deformed or broken due to expansion stress, significantly degrading optical performance of the lens module 14.

The lens module 14 according to this example embodiment may further include a configuration for addressing the above issue. For example, the lens barrel 200 according to this example embodiment may further include the support member 406 as illustrated in FIG. 15.

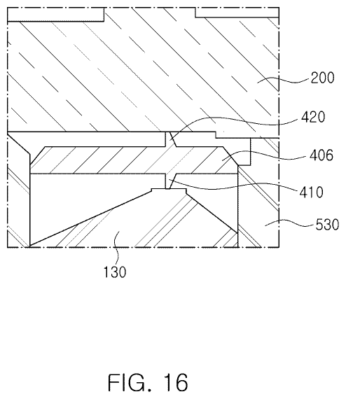

As illustrated in FIG. 16, the support member 406 may include a plurality of protrusions 410 and 420 for minimizing a contact area with the lenses 130, 150, and 170. The first protrusion 410 may protrude from an inner circumferential surface of the support member 406 toward outer circumferential surfaces of the lenses 130, 150, and 170, and the second protrusion 420 may protrude from an outer circumferential surface of the support member 406 toward an inner circumferential surface of the lens barrel 200. The first protrusion 410 and the second protrusion 420 may be alternately formed along a circumferential direction of the support member 406.

Each of the protrusions 410 and 420 may have a cross-sectional area decreasing from one end toward a distal end. For example, the distal end of each of the protrusions 410 and 420 may be substantially pointed to minimize contact areas with the lenses 130, 150, and 170 and the lens barrel 200.

The first protrusion 410 may be substantially formed not to be in contact with the outer circumferential surfaces of the lenses 130, 150, and 170. For example, a predetermined distance G1 may be formed between the end of the first protrusion 410 and the outer circumferential surfaces of the lenses 130, 150, and 170. The distance G1 may have a specific relation with the maximum expansion deformation amount X of the lenses 130, 150, and 170. For example, the distance G1 may satisfy the following conditional expression in relation to the maximum expansion deformation amount X of the lenses 130, 150, and 170: 0.3<G1/X<0.8.

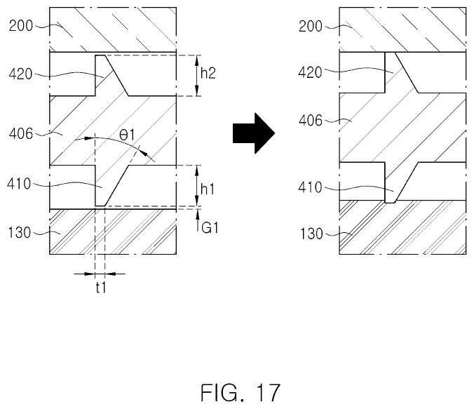

However, the end of the first protrusion 410 and the outer circumferential surfaces of the lenses 130, 150, and 170 are not always in a non-contact state. The first protrusion 410 may be inserted into the lenses 130, 150, and 170. For example, the first protrusion 410 may be inserted into ribs of the lenses 130, 150, and 170 upon expansion deformation of the lenses 130, 150, and 170 (see FIG. 17). To this end, the first protrusion 410 may have a predetermined length h1 and may be made of a material having rigidity and strength greater than those of the lenses 130, 150, and 170. The second protrusion 420 may enable bending deformation of the support member 406 or absorb the expansion stress of the lenses 130, 150, and 170 transmitted to the support member 406. For example, the support member 406 may absorb the expansion stress of the lenses 130, 150, and 170 by being bent about formation points of the first and second protrusions 410 and 420 upon the expansion deformation of the lenses 130, 150, and 170.

The length h1 of the first protrusion 410 may have a predetermined relation with an expansion deformation amount of the lenses 130, 150, and 170. For example, the length h1 of the first protrusion 410 may be greater than the expansion deformation amount of the lenses 130, 150, and 170. In an example, the length h1 of the first protrusion 410 may be 0.1 mm or more. The first protrusion 410 may be formed to substantially coincide with half points of the lenses 130, 150, and 170 in the optical axis direction. Specifically, the first protrusion 410 may be formed to coincide with a half point of a line segment connecting the object-side surface and image-side surface of each of the lenses 130, 150, and 170 (that is, a thickness of the lens). An end thickness t1 of the first protrusion 410 and the length h1 of the first protrusion 410 may have a predetermined proportional relation. For example, the end thickness t1 of the first protrusion 410 may be smaller than 1/20 of the length h1 of the first protrusion 410. The end of the first protrusion 410 may be pointed as described above. In a specific example, an angle θ1 formed between the flat surface and inclined surface of the first protrusion 410 may be 30 degrees or less.

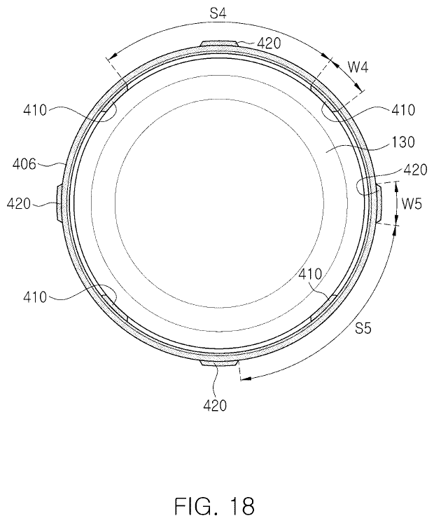

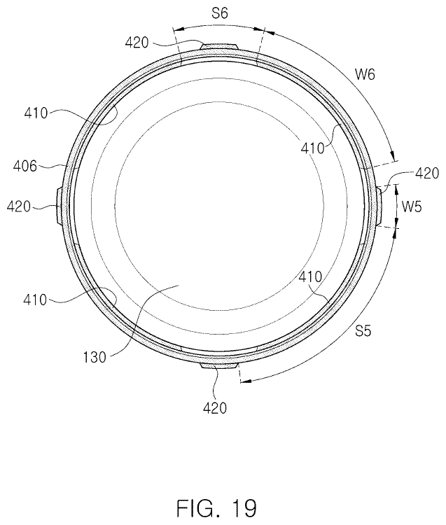

As illustrated in FIGS. 18 and 19, the first protrusion 410 and the second protrusion 420 may be disposed at predetermined distances along a circumferential direction of the support member 406. In an example, the first protrusion 410 may be formed along the circumferential direction of the support member 406 at a distance S4 wider than a width W4 of the first protrusion 410, and the second protrusion 420 may be formed along the circumferential direction of the support member 406 at a distance S5 wider than a width W5 of the second protrusion 420. In another example, the first protrusion 410 may be formed along the circumferential direction of the support member 406 at a distance S6 narrower than a width W6 of the first protrusion 410. The former form may be advantageous for supporting thin lenses 130, 150, and 170, and the latter form may be advantageous for supporting thick lenses 130, 150, and 170. However, use examples of the support member 406 are not limited to the forms of the lenses 130, 150, and 170 described above. In addition, although FIGS. 18 and 19 illustrate that the first protrusion 410 and the second protrusion 420 are formed at predetermined distances along the inner and outer circumferential surfaces of the support member 406, the first protrusion 410 and the second protrusion 420 may be formed annularly along the inner and outer circumferential surfaces of the support members 400 and 402 as needed.

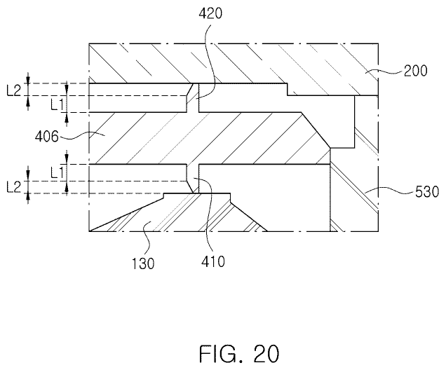

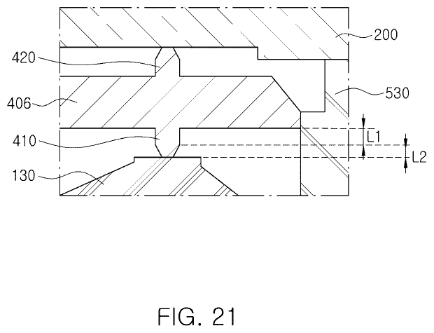

A protrusion having another form is described with reference to FIGS. 20 and 21.

The first protrusion 410 and the second protrusion 420 may include two extensions having different cross-sectional areas as illustrated in FIGS. 20 and 21. For example, the first protrusion 410 and the second protrusion 420 may include a first extension 310 having a constant cross-sectional area and a second extension 320 having a gradually reduced cross-sectional area. Specifically, the first extension 310 may have a substantially rectangular cross-sectional shape, and the second extension 320 may have a substantially triangular cross-sectional shape. The cross-sectional shape of the second extension may be a right triangle as illustrated in FIG. 20 or an isosceles triangle as illustrated in FIG. 21. The first extension and the second extension may have predetermined lengths. For example, the first extension may have a first length L1, and the second extension may have a second length L2. The first extension and the second extension may have different lengths. For example, the first length L1 may be greater than the second length L2. However, the first length L1 is not necessarily greater than the second length L2. In an example, the first length L1 may have the same size as the second length L2.

The lens module 14 configured as described above may relieve internal stress caused by expansion deformation of the lenses 130, 150, and 170 or minimize plastic deformation of the lenses 130, 150, and 170 by using the protrusions 410 and 420 formed on the support member 406.

As set forth above, the lens module according to the present disclosure may minimize the breakage or distortion of the lenses.

While specific examples have been shown and described above, it will be apparent after an understanding of this disclosure that various changes in form and details may be made in these examples without departing from the spirit and scope of the claims and their equivalents. The examples described herein are to be considered in a descriptive sense only, and not for purposes of limitation. Descriptions of features or aspects in each example are to be considered as being applicable to similar features or aspects in other examples. Suitable results may be achieved if the described techniques are performed in a different order, and/or if components in a described system, architecture, device, or circuit are combined in a different manner, and/or replaced or supplemented by other components or their equivalents. Therefore, the scope of the disclosure is defined not by the detailed description, but by the claims and their equivalents, and all variations within the scope of the claims and their equivalents are to be construed as being included in the disclosure.

What is claimed is:

1. A lens module comprising:
a lens formed of a first material; and
a lens barrel formed of a second material, different from the first material, and comprising an accommodation space accommodating the lens,
wherein a protrusion protruding toward an outer circumferential surface of the lens is disposed in the accommodation space, and
wherein conditional expression 0.3<G/X<0.8 is satisfied,
where G is a distance between an end of the protrusion and the outer circumferential surface of the lens, and X is a maximum expansion deformation amount of the lens.

2. The lens module according to claim 1, wherein the protrusion has a cross-sectional area decreasing toward an optical axis of the lens from an inner circumferential surface of the lens barrel.

3. The lens module according to claim 1, wherein the protrusion comprises:
a first extension having a first cross-sectional shape; and
a second extension having a second cross-sectional shape.

4. The lens module according to claim 3, wherein the first cross-sectional shape is rectangular and the second cross-sectional shape is triangular.

5. The lens module according to claim 1, wherein the protrusion comprises protrusions disposed at predetermined distances along an inner circumferential surface of the lens barrel.

6. The lens module according to claim 1, wherein the protrusion is disposed annularly along an inner circumferential surface of the lens barrel.

7. The lens module according to claim 1, wherein the first material has a lower strength than the second material.

8. The lens module according to claim 1, wherein the accommodation space comprises a cross-sectional area gradually decreasing from one end of the lens barrel toward the other end.

9. A lens module comprising:
a lens;
a lens barrel accommodating the lens; and
a support member disposed between the lens and the lens barrel,
wherein the support member comprises a first protrusion protruding toward an outer circumferential surface of the lens, and
wherein conditional expression 0.3<G1/X<0.8 is satisfied,
where G1 is a distance between an end of the first protrusion and the outer circumferential surface of the lens, and X is a maximum expansion deformation amount of the lens.

10. The lens module according to claim 9, wherein a step supporting the support member is disposed on an inner circumferential surface of the lens barrel.

11. The lens module according to claim 9, wherein the first protrusion comprises protrusions disposed at predetermined distances along a circumferential direction of the support member.

12. The lens module according to claim 9, wherein the first protrusion has a cross-sectional area decreasing away from the support member.

13. The lens module according to claim 9, wherein the first protrusion comprises:
a first extension having a first cross-sectional shape; and
a second extension having a second cross-sectional shape.

14. The lens module according to claim 13, wherein the first cross-sectional shape is rectangular and the second cross-sectional shape is triangular.

15. The lens module according to claim 9, wherein the support member further comprises a second protrusion protruding toward an inner circumferential surface of the lens barrel.

16. The lens module according to claim 15, wherein the first protrusion and the second protrusion are alternately disposed along a circumferential direction of the support member.
